(19) United States
(12) Patent Application Publication
(10) Pub. No.: US 2018/0087666 A1
(43) Pub. Date: Mar. 29, 2018

(54) RADIAL SHAFT SEAL ASSEMBLY WITH DEBRIS EXCLUSION MEMBER AND METHOD OF CONSTRUCTION THEREOF

(71) Applicant: Federal-Mogul Powertrain, LLC, Southfield, MI (US)

(72) Inventors: Marcie Ellen Noteboom, Armada, MI (US); Thomas Swasey, Okemos, MI (US)

(21) Appl. No.: 15/714,477

(22) Filed: Sep. 25, 2017

Related U.S. Application Data
(60) Provisional application No. 62/398,866, filed on Sep. 23, 2016.

(51) Int. Cl. F16J 15/00; F16J 15/3288; F16J 15/322

(52) U.S. Cl. CPC F16J 15/002; F16J 15/322; F16J 15/3288

(57) ABSTRACT

A radial shaft seal assembly for establishing a seal to separate an oil side from an air side of the assembly is provided. The assembly includes a metal case having a cylindrical wall with an annular leg extending radially inwardly from the cylindrical wall. A primary seal lip is operably attached to the metal case. The primary seal lip is configured for running contact with a rotatable shaft member to separate the oil side from the air side. A debris exclusion member including an annular retainer with a plurality of elongate bristles fixed thereto is fixed to one of the rotatable shaft member or the metal case, wherein the bristles extend radially free ends, with a clearance gap being established between the free ends and the other of the rotatable shaft member and the metal case.

### CROSS-REFERENCE TO RELATED APPLICATION

This application claims the benefit of U.S. Provisional Application Ser. No. 62/398,866, filed Sep. 23, 2016, which is incorporated herein by reference in its entirety.

### BACKGROUND OF THE INVENTION

### 1. Technical Field

This invention relates generally to seal assemblies, and more particularly to dynamic radial shaft seal assemblies.

### 2. Related Art

Dynamic radial shaft seals are commonly used throughout numerous types of vehicle applications. Aside from the shaft seal having a primary contact seal lip to establish a reliable seal against a running surface of a rotating shaft or wear sleeve, both to prevent the ingress of contamination and the egress of desirable lubrication, it is desirable to provide auxiliary contact seal lips to further prevent the ingress of contamination and the egress of desirable lubrication. Accordingly, it is known to construct a shaft seal having primary and auxiliary contact seal lips formed in a single operation and of the same material. Unfortunately, having to form the primary and auxiliary seal lips in a single operation and from the same material can present problems. For example, with the type of material being the same for both seal lips, the performance of one seal lip may be compromised in that the material may not be the optimal material for the particular seal lip. Further, if the seal lip material is costly, such as is often the case for auxiliary dust excluder seal lips, then economic inefficiencies may be incurred as a result of having to make the primary seal lip from the same costly material as the auxiliary seal lip. Further yet, by forming the auxiliary and primary seal lips as a single piece of material, the relative placement with one another is fixed, thereby negating any ability to adjust the position of one of the seal lips relative to the other, and further, restricts use of the seal assembly to a dedicated application.

### SUMMARY OF THE INVENTION

A radial shaft seal assembly for establishing a seal between an oil side and an air side of the assembly, constructed in accordance with one aspect of the disclosure, includes a metal case having a wall extending cylindrically about a central axis with an annular leg extending radially inwardly from the wall toward the central axis. A primary seal lip is operably attached to the metal case for running contact with a rotatable shaft member to separate the oil side of the assembly from the air side of the seal assembly. A debris exclusion member including an annular retainer with a plurality of elongate bristles is fixed to one of the rotatable shaft member or the metal case, wherein the bristles extend radially toward the other of the rotatable shaft member or the metal case to free ends. A clearance gap is established between the free ends of the bristles and the other of the rotatable shaft member and the metal case.

In accordance with another aspect of the disclosure, the radial shaft seal assembly can further include an elastomeric material bonded to the leg, with the primary seal lip being attached to the elastomeric material.

In accordance with another aspect of the disclosure, the elastomeric material can form at least one debris exclusion lip extending toward the air side of the assembly.

In accordance with another aspect of the disclosure, the at least one debris exclusion lip can extend radially inwardly from the annular leg toward the rotatable shaft member with a clearance gap being established between the at least one debris exclusion lip and the rotatable shaft member.

In accordance with another aspect of the disclosure, the debris exclusion member can be fixed to the metal case with the bristles extending radially inwardly toward the rotatable shaft member.

In accordance with another aspect of the disclosure, the debris exclusion member can be fixed to the rotatable shaft member with the bristles extending radially outwardly toward the metal case.

In accordance with another aspect of the disclosure, the at least one debris exclusion lip can extend radially outwardly from the annular leg toward the debris exclusion member with a clearance gap being established between the at least one debris exclusion lip and the debris exclusion member.

In accordance with another aspect of the disclosure, the annular retainer of the debris exclusion member can be fixed to the metal case at least in part by a folded rim of the metal case.

In accordance with another aspect of the disclosure, the annular retainer of the debris exclusion member can be fixed to the metal case by a molded elastomeric material.

In accordance with another aspect of the disclosure, the annular retainer of the debris exclusion member can be fixed to the metal case via a snap fit within an annular groove in the molded elastomeric material.

In accordance with another aspect of the disclosure, the rotatable shaft member can include a wear sleeve and a shaft, with the wear sleeve having a cylindrical wall configured for a tight fit on the shaft and having an annular flange extending radially outwardly from the cylindrical wall, wherein the bristles extend radially between the annular flange and the annular leg of the metal case in clearance relation therewith.

In accordance with another aspect of the disclosure, the retainer of the debris exclusion member can be fixed to the cylindrical wall of the wear sleeve.

In accordance with another aspect of the disclosure, the retainer of the debris exclusion member can be fixed to the wear sleeve at least in part by a folded rim of the wear sleeve cylindrical wall.

In accordance with another aspect of the disclosure, the annular flange of the wear sleeve can extend radially between the bristles and the annular leg of the metal case in clearance relation therewith.

In accordance with another aspect of the disclosure, the at least one debris exclusion lip can include a secondary debris exclusion lip and a tertiary debris exclusion lip. The secondary debris exclusion lip extends radially inwardly from the annular leg toward the rotatable shaft member with a clearance gap being established between the secondary debris exclusion lip and the rotatable shaft member and the tertiary debris exclusion lip extends radially outwardly from the annular leg toward the debris exclusion member with a clearance gap being established between the tertiary debris exclusion lip and the debris exclusion member.

In accordance with another aspect of the disclosure, the wear sleeve can include an annular flange extending radially outwardly from the cylindrical wall, with the annular flange having cylindrical shoulder formed therein and the retainer of the debris exclusion member being fixed on the shoulder.

In accordance with another aspect of the disclosure, the retainer of the debris exclusion member can be fixed on the shoulder by a retaining washer.

In accordance with another aspect of the disclosure, a method of constructing radial shaft seal assembly for establishing a seal between an oil side and an air side of the assembly is provided. The method includes forming a metal case having a wall extending cylindrically about a central axis with an annular leg extending radially inwardly from the wall toward the central axis. Further, operably attaching a primary seal lip to the metal case and configuring the primary seal lip for running contact with a rotatable shaft member to separate the oil side of the assembly from the air side of the seal assembly. Further yet, attaching an annular retainer, having a plurality of elongate bristles attached thereto, of a debris exclusion member to one of the rotatable shaft member or the metal case, with the bristles extending radially toward the other of the rotatable shaft member or the metal case to free ends of the bristles, and configuring the free ends of the bristles so that a clearance gap is established between the free ends and the other of the rotatable shaft member and the metal case.

In accordance with another aspect of the disclosure, the method can further include bonding an elastomeric material to the leg and attaching the primary seal lip to the elastomeric material.

In accordance with another aspect of the disclosure, the method can further include forming the elastomeric material to provide at least one debris exclusion lip extending toward the air side of the assembly.

In accordance with another aspect of the disclosure, the method can further include forming the at least one debris exclusion lip to provide a secondary debris exclusion lip and a tertiary debris exclusion lip, and forming the secondary debris exclusion lip to extend radially inwardly from the annular leg toward the rotatable shaft member with a clearance gap being established between the secondary debris exclusion lip and the rotatable shaft member and forming the tertiary debris exclusion lip to extend radially outwardly from the annular leg toward the debris exclusion member with a clearance gap being established between the tertiary debris exclusion lip and the debris exclusion member.

In accordance with another aspect of the disclosure, the method can further include fixing the debris exclusion member to the metal case with the bristles extending radially inwardly toward the rotatable shaft member.

In accordance with another aspect of the disclosure, the method can further include fixing the debris exclusion member to the rotatable shaft member with the bristles extending radially outwardly toward the metal case.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a cross-sectional view of a radial shaft seal assembly constructed in accordance with one aspect of the invention shown disposed about a shaft;

FIG. 1A is a plan view of a debris exclusion member of the radial shaft seal assembly of FIG. 1 in accordance with one aspect of the invention;

FIG. 2 is a view similar to FIG. 1 of a radial shaft seal assembly constructed in accordance with another aspect of the invention;

FIG. 3 is a view similar to FIG. 1 of a radial shaft seal assembly constructed in accordance with another aspect of the invention;

FIG. 4 is a view similar to FIG. 1 of a radial shaft seal assembly constructed in accordance with another aspect of the invention;

FIG. 5 is a view similar to FIG. 1 of a radial shaft seal assembly constructed in accordance with another aspect of the invention;

FIG. 6 is a view similar to FIG. 1 of a radial shaft seal assembly constructed in accordance with another aspect of the invention;

FIG. 7 is a view similar to FIG. 1 of a radial shaft seal assembly constructed in accordance with another aspect of the invention;

FIG. 7A is a plan view of a debris exclusion member of the radial shaft seal assembly of FIG. 7 in accordance with another aspect of the invention;

FIG. 8 is a view similar to FIG. 1 of a radial shaft seal assembly constructed in accordance with another aspect of the invention;

FIG. 9 is a view similar to FIG. 1 of a radial shaft seal assembly constructed in accordance with another aspect of the invention;

FIG. 10 is a view similar to FIG. 1 of a radial shaft seal assembly constructed in accordance with another aspect of the invention;

FIG. 11 is a view similar to FIG. 1 of a radial shaft seal assembly constructed in accordance with another aspect of the invention; and

FIG. 12 is a view similar to FIG. 1 of a radial shaft seal assembly constructed in accordance with yet another aspect of the invention.

### DETAILED DESCRIPTION OF PRESENTLY PREFERRED EMBODIMENTS

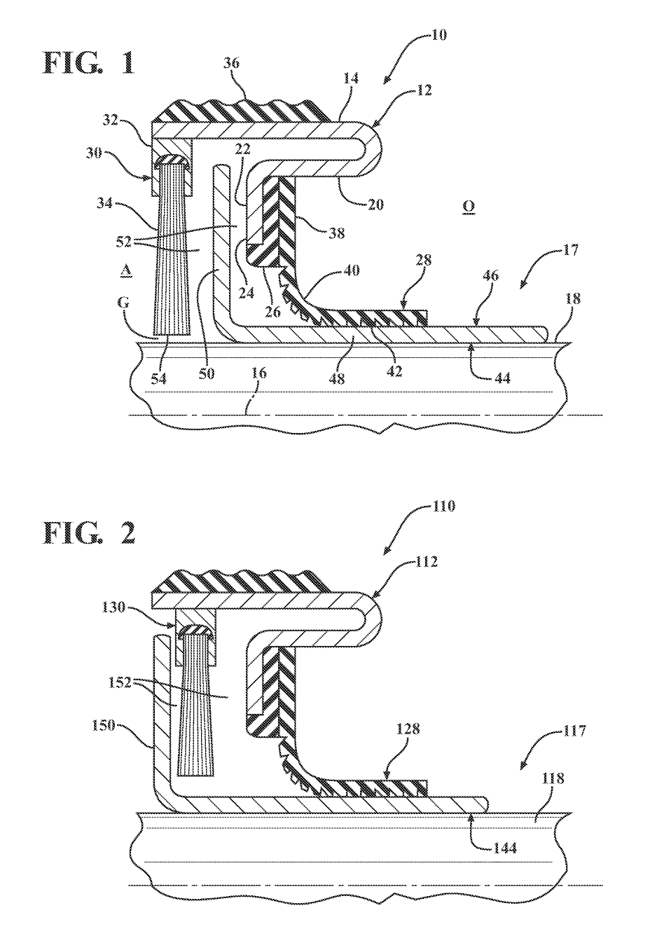

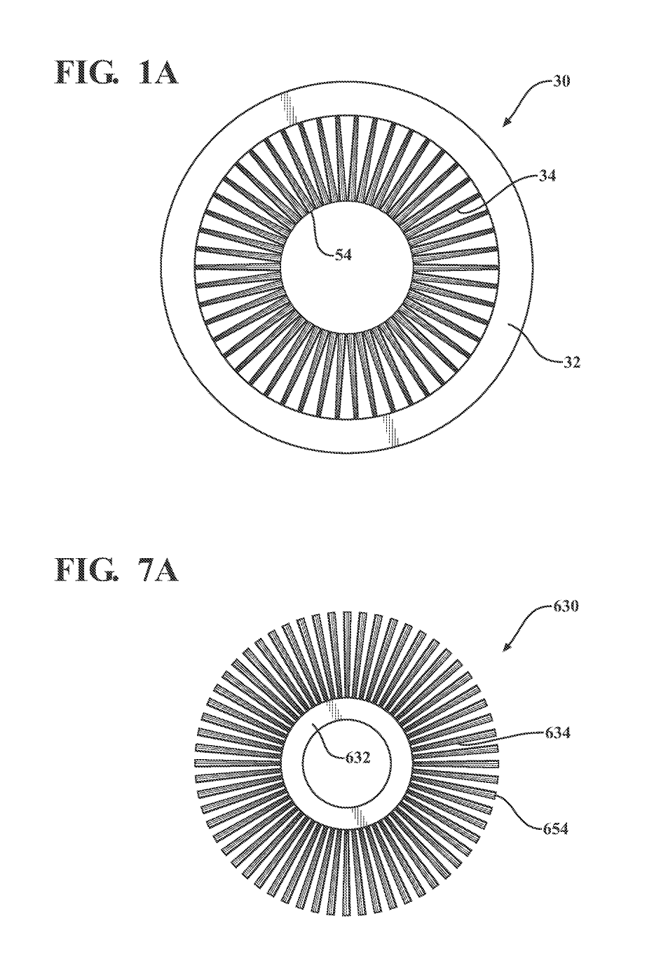

Referring in more detail to the drawings, FIG. 1 illustrates a cross-section view, taken along a central longitudinal axis of a radial shaft seal assembly, referred to hereafter as assembly 10, constructed in accordance with one aspect of the invention. It is to be recognized that the assembly is annular, as discussed herein, and that one skilled in the art would readily understand the assembly 10, as shown in axial cross-section, is symmetrical or generally symmetrical about it circumference. The assembly 10 has an annular outer metal case 12 having an outer wall 14 that extends cylindrically or substantially cylindrically (substantially is intended to mean the wall 14 may be slightly less than purely cylindrical, and thus, the outer wall may have a slight taper) about a central axis 16 of a rotatable shaft member 17 wherein of the assembly 10, wherein the shaft member 17 can be provided solely by a shaft 18 or may otherwise include a wear sleeve 44, as will be ready understood by one possessing ordinary skill in the art upon view the disclosure herein. The case 12 is shown, by way of example and without limitation, as having a reverse folded portion 20 extending back beneath the outer wall 14. The reverse folded portion transitions to leg 22 that extends radially inwardly from and beneath the wall 14 toward the central axis 16 to a free end 24. It should be recognized that the shape of the case 12 is not limited to the shape illustrated, and that any suitable shape configured for operable attachment to an outer housing (not shown) is contemplated to be within the scope of the disclosure. The assembly 10 further includes a body 26 of elastomeric material, e.g. low cost elastomeric material, e.g. rubber, bonded to the leg 22. An annular primary seal lip 28 is shown as being operably attached, meaning the primary seal lip 28 is attached to the leg 22 via an intermediate material, to the case 12 via the elastomeric material 20, by way of example and without limitation, wherein the primary seal lip 28 separates an oil side O of the assembly 10 from an air side A of the assembly 10. The assembly 10 further includes a debris exclusion member 30 (FIG. 1A) including an annular retainer 32 with a plurality of elongate bristles 34 fixed thereto. The bristles 34 extend radially away from the retainer 32 to free ends 54 of the bristles 34, wherein the bristles 34 can be configured to make selective contact with the select components of the seal assembly 10 and/or the shaft member 17, or, in order to minimize running friction of the assembly 10, the bristles 34 can be provided to remain free from contact with the seal assembly 10 and the shaft member 17. Accordingly, while the debris exclusion member 30 presents a barrier to the ingress of debris from the air side A to the oil side O of the assembly 10, the debris exclusion member 30 can be provided to minimize the amount of running friction and wear and to avoid impeding the free rotation of the shaft member 17 relative to the primary seal lip 28.

The elastomeric material 26 can be molded about the entire or substantially an entire outer surface of the case 12. As such, a radially outermost portion 36 of the elastomeric material 26 can be molded about an outer surface of the outer wall 14, wherein the outermost portion 36 is sized on diameter to be received in a bore of a housing (not shown), such as in a line-to-line or slight interference press fit. In addition, the elastomeric material 26 can be molded about a portion or the entirety of the leg 22, if desired, thereby providing protection to the case 12 against corrosion, or to provide other features, as discussed further below.

The primary seal lip 28, such as a PTFE seal element, by way of example and without limitation, has a first portion 38 bonded to the elastomeric material 26 and a second portion 40 that extends radially inwardly from the first portion 38. The bonded portion 38 is shown as extending along the entirety or substantial entirety of the length of the leg 22, wherein substantial entirety is intended to mean that the bonded portion 38 could extend along less that the entire length of the leg 22, but preferably a majority of the length. The second portion 40 extends freely from the elastomeric material 20 in unsupported, non-bonded relation therewith to provide a sealing surface 42 of the primary seal lip 22, wherein while in an uninstalled state, the unsupported portion extends radially inwardly beyond a running surface of the shaft member 17. Then, upon being installed about the shaft member 17, the sealing surface 42 of the unsupported elongate portion is caused to extend parallel to the central axis 16 and sealingly engage a radially outwardly facing running surface 46 of the shaft member 17, shown as a running surface of the wear sleeve 44, with an amount of bias that is predetermined, based on the physical and material characteristics of the unsupported portion. While installed, the flexing of the PTFE primary seal lip 28 against the wear sleeve 44 occurs entirely over the elongate unsupported portion and not within the bonded first portion 38. Accordingly, the amount of flex of the unsupported second portion 40 and the magnitude of sealing force imparted thereby can be tightly controlled.

The wear sleeve 44 is shown as being generally L-shaped, having a generally cylindrical wall 48 sized for close, tight fit about the shaft 18, and having an annular rim, also referred to as leg or flange 50 extending radially outwardly from the wall 48. Upon completing installation of the seal assembly 10 on the shaft 18, the flange 50 is received between the debris exclusion member 30 and the leg 22 of the case 12, as well as between the debris exclusion member 30 and the primary seal lip 28. The flange 50 remains in an axially spaced relation from, and in a non-contact clearance fit with the debris exclusion member 30 and the leg 22, thereby forming a clearance serpentine labyrinth 52 to facilitate minimizing running friction, while also preventing the ingress of debris from the air side A to the oil side O.

The debris exclusion member 30 is shown as being fixed to the metal case 12, wherein the retainer 32 is shown as being fixed to an inner surface of the outer wall 14. The mechanism for fixing the retainer 32 to the inner surface of the outer wall 14 can include one or more of a suitable metal adhesive, a press fit, and/or a weld joint, by way of example and without limitation. Upon being fixed to the outer wall 14, the bristles 34 are of a length to extend radially inwardly to free ends 54, wherein the free ends 54 can be configured to make slight contact with the shaft member 17, such as the shaft 18 or wear sleeve 44, or to the contrary, can be configured to remain entirely free from interference with the respective shaft member 17, thereby forming an annular clearance gap G therebetween. The radial extent of the gap G can be tightly controlled to optimally inhibit the ingress of debris from the air side A to the oil side O, while preventing friction from the resulting between the bristles 34 and the shaft member 17, including the shaft 18 and wear sleeve 44.

In FIG. 2, a rotary shaft seal assembly 110 constructed in accordance with another aspect of the invention is illustrated, wherein the same reference numerals, offset by a factor of 100, are used to indicate like features discussed above.

The assembly 110 is similar to the previous assembly 10, and thus, aside from the differences discussed hereafter, all else remains the same, as would be readily recognized by one possessing ordinary skill in the art, particularly in view of the drawings. The assembly 110 includes the metal case 112, primary seal lip 128, debris exclusion member 130, and shaft member 117 including a shaft 118 and wear sleeve 144; however, rather than an annular flange 150 of the wear sleeve 144 extending between the debris exclusion member 130 and a leg 122 of the case 112, the debris exclusion member 130 extends in axially spaced relation from and between the flange 150 and the leg 122 with a clearance serpentine labyrinth 152 being establish therebetween. Otherwise, as can be seen in FIG. 2, all else remains the same, as identified in the drawings, and thus, is not discussed further.

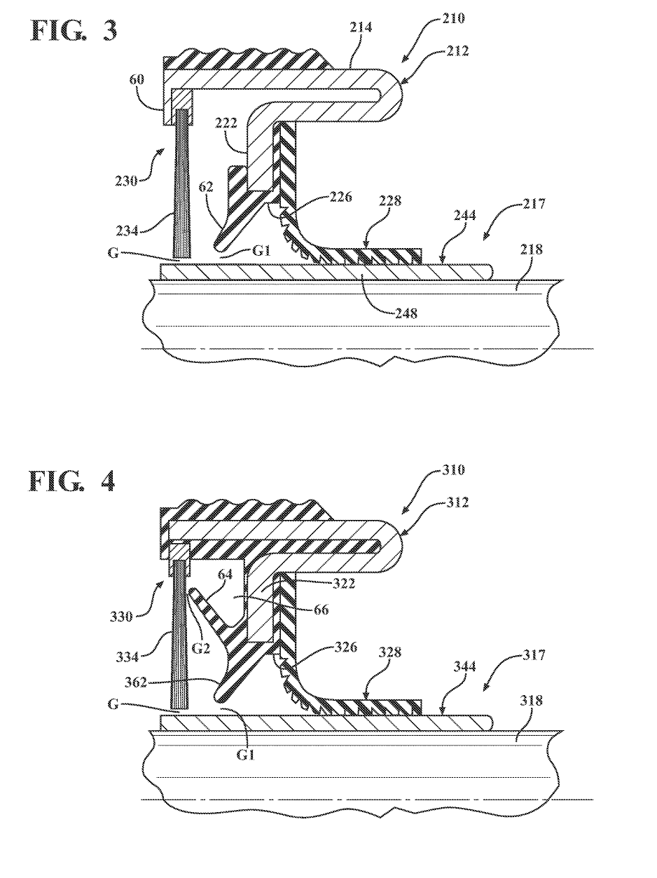

In FIG. 3, a rotary shaft seal assembly 210 constructed in accordance with another aspect of the invention is illustrated, wherein the same reference numerals, offset by a factor of 200, are used to indicate like features discussed above.

The assembly 210 is similar to the assembly 10, and thus, aside from the differences discussed hereafter, all else remains the same, as would be readily recognized and understood by one possessing ordinary skill in the art, particularly in view of the drawings. The assembly 210 includes the metal case 212, primary seal lip 228, debris exclusion member 230, and shaft member 217 including a shaft 218 and wear sleeve 244; however, rather than the wear sleeve 244 having a radially outwardly extending flange, the wear sleeve 244 is formed solely via a cylindrical wall 248. Further yet, the debris exclusion member 230 is fixed to a cylindrical wall 214 of the metal case 212 at least in part by a folded rim 60 of the metal case 212. In addition, an elastomeric body 226 can further be formed including at least one exclusion lip, shown as a single secondary debris exclusion lip 62, by way of example and without limitation, wherein the secondary debris exclusion lip 62 is shown as extending toward the air side A of the assembly 210. The secondary debris exclusion lip 62 is shown as remaining out of contact with any shaft member 217 and seal assembly features, and, by way of example and without limitation, is shown as extending radially inwardly from the leg 222 into slightly spaced relation from the shaft member 17 formed by a wear sleeve cylindrical wall 248, thereby forming an annular gap G1 therebetween. As such, bristles 234 of the debris exclusion member 230 and a free end of the lip 62 are adjacent one another, but not in contact with one another, with a narrow or slight labyrinth passage G1 being formed therebeneath. With the labyrinth passage G1 being slight or narrow, such as between about 0.5-5 mm, and more preferably between about 0.5-2 mm, and even more preferably between about 0.5-2 mm, debris is inhibited from passing thereby, while at the same time minimizing the amount of running friction of the assembly 210. Otherwise, as can be seen in FIG. 3, all else remains the same, as identified in the drawings, and thus, is not discussed further.

In FIG. 4, a rotary shaft seal assembly 310 constructed in accordance with another aspect of the invention is illustrated, wherein the same reference numerals, offset by a factor of 300, are used to indicate like features discussed above.

The assembly 310 is similar to the previous assembly 310, and thus, aside from the differences discussed hereafter, all else remains the same, as would be readily recognized and understood by one possessing ordinary skill in the art, particularly in view of the drawings. The assembly 310 includes the metal case 312, primary seal lip 328, debris exclusion member 330, shaft member 317 including a shaft 318 and wear sleeve 344, elastomeric body 326 including a secondary debris exclusion lip 362, and further yet, the elastomeric body 326 further forms a tertiary debris exclusion lip 64, shown as extending radially outwardly from the leg 322 into slightly spaced relation from the debris exclusion member 330, thereby forming a gap G2 between the tertiary debris exclusion lip 64 and the debris exclusion member 330. As such, the bristles 334 of the debris exclusion member 330 and a free end of the lip 64 are adjacent one another, with a clearance labyrinth passage being formed therebetween, and further forming a toroid shaped receptacle 66 between the tertiary debris exclusion lip 64 and the leg 322, with the generally V-shaped receptacle 66 acting as a catch basin for debris, should any make it into the region thereof. Otherwise, as can be seen in FIG. 4, all else remains the same, as identified in the drawings, and thus, is not discussed further.

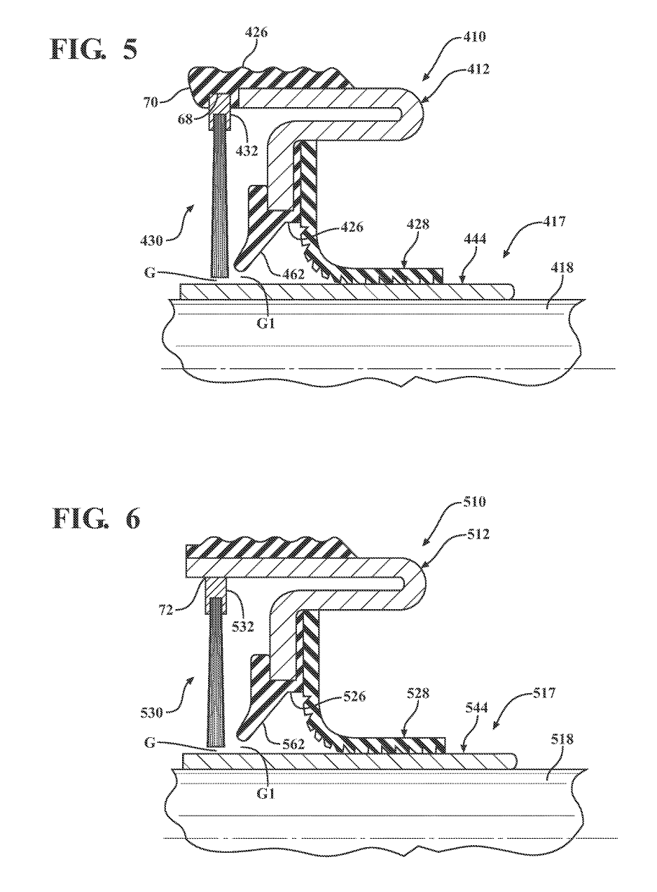

In FIG. 5, a rotary shaft seal assembly 410 constructed in accordance with another aspect of the invention is illustrated, wherein the same reference numerals, offset by a factor of 400, are used to indicate like features discussed above.

The assembly 410 is similar to the assembly 210, and thus, aside from the differences discussed hereafter, all else remains the same, as would be readily recognized and understood by one possessing ordinary skill in the art, particularly in view of the drawings. The assembly 410 includes a metal case 412, primary seal lip 428, debris exclusion member 430, shaft member 417 including a shaft 418 and wear sleeve 444, and elastomeric body 426 including a secondary debris exclusion lip 462. The notable difference is with regard to the mechanism used to attach the debris exclusion member 430 to the metal case 412. Rather than being fixed via a curled lip of the metal case, a retainer 432 of the exclusion member 430 is disposed with an annular groove 68 formed in the elastomeric material of the elastomeric body 426. The groove 68 can be bounded on an air side by a flexible lip 70 of the body 426, wherein the lip 70 can facilitate installation of the exclusion member 430 into the groove 68, such as via a snap fit therein. Otherwise, as can be seen in FIG. 5, all else remains the same, as identified in the drawings, and thus, is not discussed further.

In FIG. 6, a rotary shaft seal assembly 510 constructed in accordance with another aspect of the invention is illustrated, wherein the same reference numerals, offset by a factor of 500, are used to indicate like features discussed above.

The assembly 510 is similar to the assembly 210, and thus, aside from the differences discussed hereafter, all else remains the same, as would be readily recognized by one possessing ordinary skill in the art, particularly in view of the drawings. The assembly 510 includes a metal case 512, primary seal lip 528, debris exclusion member 530, shaft member 517 including a shaft 518 and wear sleeve 544, and elastomeric body 526 including a secondary debris exclusion lip 562. The notable difference is with regard to the mechanism used to attach the debris exclusion member 530 to the metal case 512. Rather than being fixed via a curled lip of the metal case, a retainer 532 of the exclusion member 530 is disposed into close fit, such as in a slight interference or line-to-line fit against an inner surface of a cylindrical wall 514 of the case 512, for example, and a bond joint 72 is formed between the retainer 532 and the inner surface of the wall 514. The bond joint 72 can be formed via any suitable metal adhesive or weld joint, for example. Otherwise, as can be seen in FIG. 6, all else remains the same, as identified in the drawings, and thus, is not discussed further.

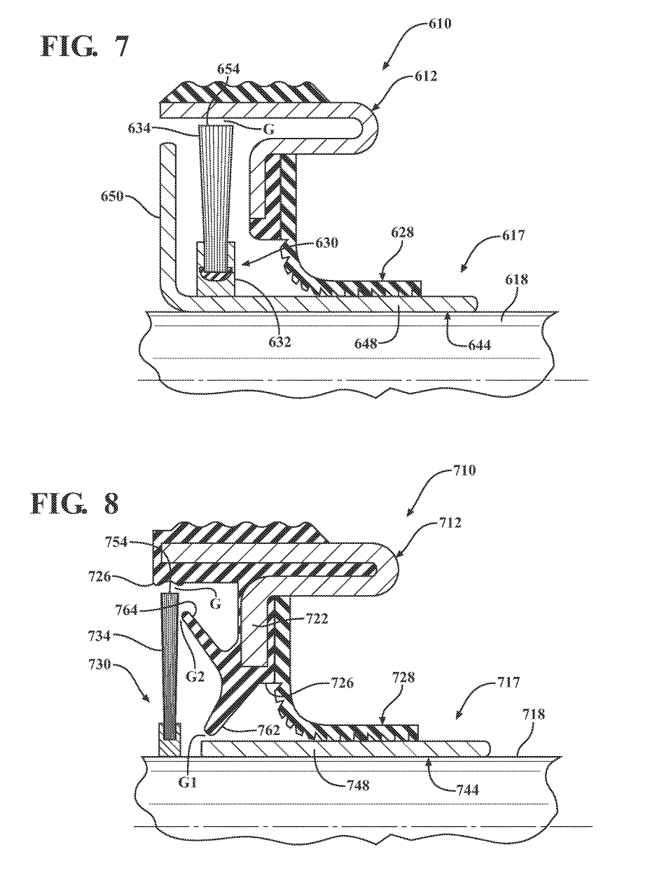

In FIG. 7, a rotary shaft seal assembly 610 constructed in accordance with another aspect of the invention is illustrated, wherein the same reference numerals, offset by a factor of 600, are used to indicate like features discussed above.

The assembly 610 is similar to the assembly 110, and thus, aside from the differences discussed hereafter, all else remains the same, as would be readily recognized by one possessing ordinary skill in the art, particularly in view of the drawings. The assembly 610 includes the metal case 612, primary seal lip 628, debris exclusion member 630 (FIG. 7A), and shaft member 617 including a shaft 618 and wear sleeve 644; however, rather than the debris exclusion member 630 being fixed to the metal case 612 in static relation therewith, the debris exclusion member 630 is fixed to the wear sleeve 644 for co-rotation therewith. The debris exclusion member 630 is shown extending between a flange 650 of the wear sleeve 644 and a leg 622 of the case 614, with a retainer 632 of the exclusion member 630 being fixed to the cylindrical wall 648 of the wear sleeve 644. With the debris exclusion member 630 being fixed for co-rotation with the wear sleeve 644 and shaft 618, any debris that makes its way into bristles 634 of the exclusion member 630 is flung radially outwardly via centripetal force, and thus, the bristles 634 are self-cleaning. As shown, a gap G can be established between free ends 654 of the bristles and an inner surface of the case 612, thereby minimizing friction and wear during use; however, it is contemplated that the bristles could make contact with the inner surface of the case 612 or another member, as desired. Otherwise, as can be seen in FIG. 7, all else remains the same, as identified in the drawings, and thus, is not discussed further.

In FIG. 8, a rotary shaft seal assembly 710 constructed in accordance with another aspect of the invention is illustrated, wherein the same reference numerals, offset by a factor of 700, are used to indicate like features discussed above.

The assembly 710 is similar to the assembly 610, and thus, aside from the differences discussed hereafter, all else remains the same, as would be readily recognized by one possessing ordinary skill in the art, particularly in view of the drawings. The assembly 710 includes the metal case 712, primary seal lip 728, debris exclusion member 730, and shaft member 717 including a shaft 718 and wear sleeve 744, with the wear sleeve 744 being formed solely via the cylindrical wall 748; however, rather than the debris exclusion member 730 being fixed to the shaft member wear sleeve 744, the debris exclusion member 730 is fixed to the shaft 718 for co-rotation therewith. With the debris exclusion member 730 being fixed for co-rotation with the shaft 718, any debris that makes its way into bristles 734 of the exclusion member 730 is flung radially outwardly via centripetal force, and thus, the bristles 734 are self-cleaning. As shown, a gap G is established between free ends 754 of the bristles 734 and an elastomeric body 726, wherein the elastomeric body 726 is shown including a secondary debris exclusion lip 762, shown as extending radially inwardly from the leg 722 into slightly spaced relation from the wear sleeve wall 748, thereby forming a clearance gap G1 therebetween, and further including a tertiary debris exclusion lip 764, shown as extending radially outward from the leg 722 into slightly spaced relation from the bristles 734, thereby forming a clearance gap G2 therebetween. Otherwise, as can be seen in FIG. 8, all else remains the same, as identified in the drawings, and thus, is not discussed further.

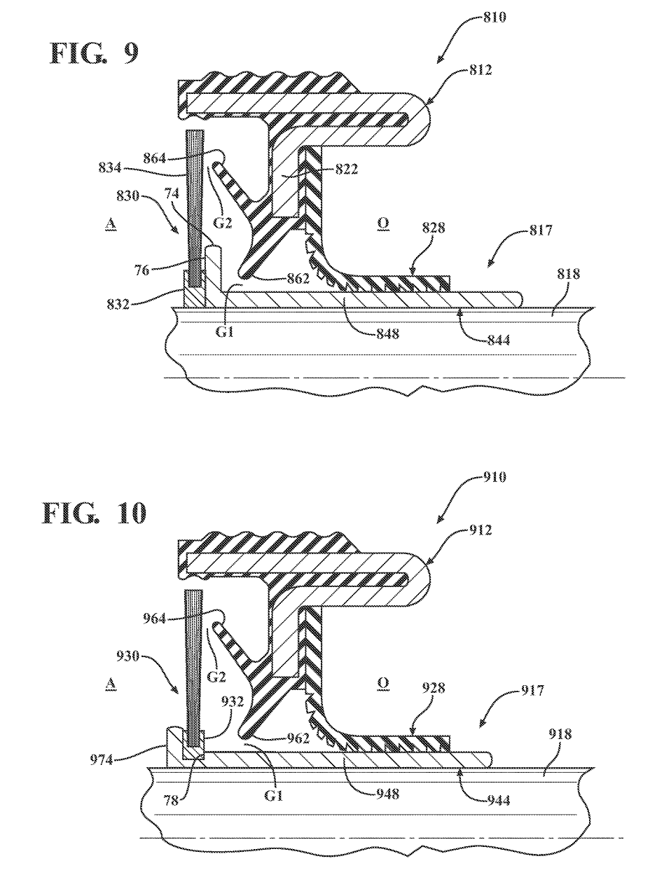

In FIG. 9, a rotary shaft seal assembly 810 constructed in accordance with another aspect of the invention is illustrated, wherein the same reference numerals, offset by a factor of 800, are used to indicate like features discussed above.

The assembly 810 is similar to the assembly 710, and thus, aside from the differences discussed hereafter, all else remains the same, as would be readily recognized by one possessing ordinary skill in the art, particularly in view of the drawings. The assembly 810 includes the metal case 812, primary seal lip 828, debris exclusion member 830, and shaft member 817 including a shaft 818 and wear sleeve 844, with the wear sleeve 844 having a cylindrical wall 848 and an end lip 74 extending radially outwardly from the wall 848; however, rather than the debris exclusion member 830 being fixed solely to the shaft 818, a retainer 832 of the debris exclusion member 830 is fixed to an axially facing (toward air side A and away from oil side O) end face 76 of the lip 74 for co-rotation therewith. The retainer 832 can be fixed to the end face 76 via any suitable metal adhesive or weld joint. With the debris exclusion member 830 being fixed for co-rotation with the shaft 818 and the wear sleeve 844, any debris that makes its way into bristles 834 of the exclusion member 830 is flung radially outwardly via centripetal force, and thus, the bristles 834, which tend to open during high speed rotation, are self-cleaning. As shown, the assembly 810 further includes a secondary debris exclusion lip 862, shown as extending radially inwardly from the leg 822 into slightly spaced relation from the wear sleeve wall 848, thereby forming a gap G1 therebetween, and further including a tertiary debris exclusion lip 864, shown as extending radially outward from the leg 822 into slightly spaced relation from the bristles 834, thereby forming a gap G2 therebetween. Otherwise, as can be seen in FIG. 9, all else remains the same, as identified in the drawings, and thus, is not discussed further.

In FIG. 10, a rotary shaft seal assembly 910 constructed in accordance with another aspect of the invention is illustrated, wherein the same reference numerals, offset by a factor of 900, are used to indicate like features discussed above.

The assembly 910 is similar to the assembly 810, and thus, aside from the differences discussed hereafter, all else remains the same, as would be readily recognized by one possessing ordinary skill in the art, particularly in view of the drawings. The assembly 910 includes the metal case 912, primary seal lip 928, debris exclusion member 930, and shaft member 917 including a shaft 918 and wear sleeve 944, with the wear sleeve 944 having a cylindrical wall 948 and an end lip 974 extending radially outwardly from the wall 948; however, rather than the debris exclusion member 930 being fixed to an axially facing toward air side A and away from oil side O, a retainer 932 of the debris exclusion member 930 is captured by the lip 974 on an oil side O of the lip 974. The retainer 932 can be pressed onto a thinned region of the cylindrical wall 948 against an upstanding shoulder 78, and then the thinned lip 974 can be curled or otherwise folded radially outwardly to fixedly capture the retainer 932 on a radially outwardly facing surface of the wear sleeve 944 for co-rotation therewith. The assembly 910 further includes a secondary debris exclusion lip 962 and a tertiary debris exclusion lip 964, as described above. Otherwise, as can be seen in FIG. 10, all else remains the same, as identified in the drawings, and thus, is not discussed further.

In FIG. 11, a rotary shaft seal assembly 1010 constructed in accordance with another aspect of the invention is illustrated, wherein the same reference numerals, offset by a factor of 1000, are used to indicate like features discussed above.

The assembly 1010 is similar to the assembly 910, and thus, aside from the differences discussed hereafter, all else remains the same, as would be readily recognized by one possessing ordinary skill in the art, particularly in view of the drawings. The assembly 1010 includes the metal case 1012, primary seal lip 1028, debris exclusion member 1030, and shaft member 1017 including a shaft 1018 and wear sleeve 1044, with the wear sleeve 1044 having a cylindrical wall 1048 and an end lip 1074 extending radially outwardly from the wall 1048; however, rather than the debris exclusion member 1030 being fixed to the wear sleeve 1044 solely by the lip 1074, an annular retaining washer 80 is pressed onto an axially extending shoulder formed in the lip 1074, thereby capturing the retainer 1032 in fixed relation to the wear sleeve 1044 for conjoint, co-rotation of the debris exclusion member 1030 with the wear sleeve 1044. The assembly 1010 further includes a secondary debris exclusion lip 1062 and a tertiary debris exclusion lip 1064, as described above. Otherwise, as can be seen in FIG. 11, all else remains the same, as identified in the drawings, and thus, is not discussed further.

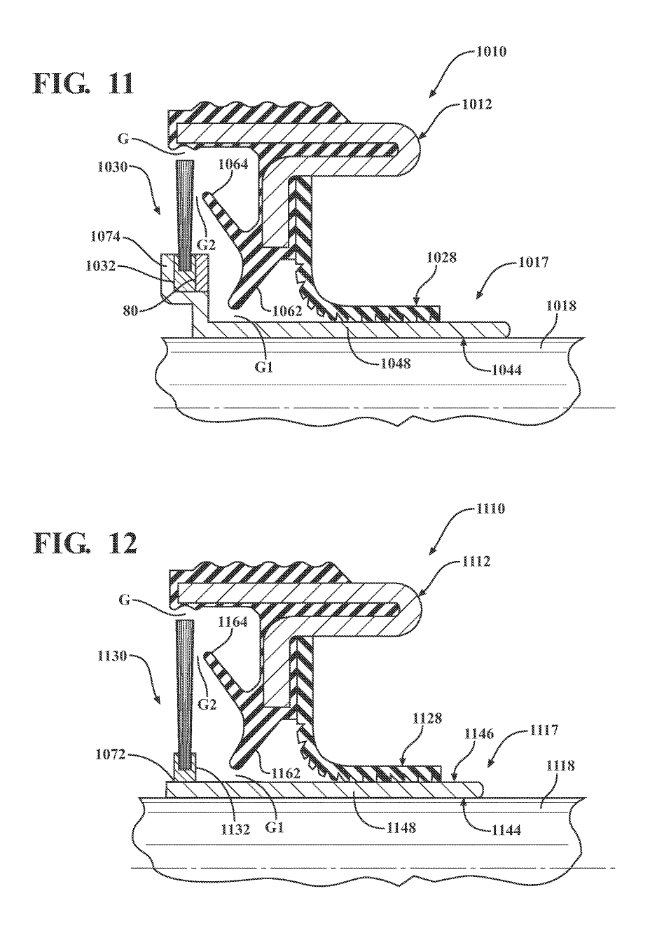

In FIG. 12, a rotary shaft seal assembly 1110 constructed in accordance with another aspect of the invention is illustrated, wherein the same reference numerals, offset by a factor of 1100, are used to indicate like features discussed above.

The assembly 1110 is similar to the assembly 710, and thus, aside from the differences discussed hereafter, all else remains the same, as would be readily recognized by one possessing ordinary skill in the art, particularly in view of the drawings. The assembly 1110 includes the metal case 1112, primary seal lip 1128, debris exclusion member 1130, and shaft member 1117 including a shaft 1118 and wear sleeve 1144, with the wear sleeve 1144 being formed solely via a cylindrical wall 1148; however, rather than the debris exclusion member 1130 being fixed to the shaft 1118 as with the assembly 710, the debris exclusion member 1130 is fixed on a running surface 1146 of the sleeve 1144 for co-rotation therewith. A retainer 1132 of the exclusion member 1130 can be sized for a close fit, such as a line-to-line or slight interference fit, on the wear sleeve 1144, wherein a bond joint 1172 can be formed between the retainer 1132 and the wear sleeve 1144. The bond joint 1172 can be formed via any suitable metal adhesive or weld joint, for example. The assembly 1110 further includes a secondary debris exclusion lip 1162 and a tertiary debris exclusion lip 1164, as described above. Otherwise, as can be seen in FIG. 12, all else remains the same, as identified in the drawings, and thus, is not discussed further.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A radial shaft seal assembly for establishing a seal between an oil side and an air side of the assembly, comprising:
a metal case having a wall extending cylindrically about a central axis with an annular leg extending radially inwardly from the wall toward the central axis;
a primary seal lip operably attached to said metal case, said primary seal lip configured for running contact with a rotatable shaft member to separate the oil side of the assembly from the air side of the seal assembly; and
a debris exclusion member including an annular retainer with a plurality of elongate bristles fixed thereto, said annular retainer being fixed to one of the rotatable shaft member or said metal case, with said bristles extending radially toward the other of the rotatable shaft member or said metal case to free ends of said bristles, wherein a clearance gap is established between said free ends and said other of the rotatable shaft member and said metal case.

2. The radial shaft seal assembly of claim 1, further including an elastomeric material bonded to said leg, said primary seal lip being attached to said elastomeric material.

3. The radial shaft seal assembly of claim 2, where said elastomeric material forms at least one debris exclusion lip extending toward the air side of the assembly.

4. The radial shaft seal assembly of claim 3, wherein said at least one debris exclusion lip extends radially inwardly from said annular leg toward said rotatable shaft member with a clearance gap being established between said at least one debris exclusion lip and said rotatable shaft member.

5. The radial shaft seal assembly of claim 4, wherein said debris exclusion member is fixed to said metal case with said bristles extending radially inwardly toward the rotatable shaft member.

6. The radial shaft seal assembly of claim 4, wherein said debris exclusion member is fixed to the rotatable shaft member with said bristles extending radially outwardly toward said metal case.

7. The radial shaft seal assembly of claim 3, wherein said at least one debris exclusion lip extends radially outwardly from said annular leg toward said debris exclusion member with a clearance gap being established between said at least one debris exclusion lip and said debris exclusion member.

8. The radial shaft seal assembly of claim 7, wherein said debris exclusion member is fixed to said metal case with said bristles extending radially inwardly toward the rotatable shaft member.

9. The radial shaft seal assembly of claim 7, wherein said debris exclusion member is fixed to said rotatable shaft member with said bristles extending radially outwardly toward said metal case.

10. The radial shaft seal assembly of claim 1, wherein said annular retainer of said debris exclusion member is fixed to said metal case at least in part by a folded rim of said metal case.

11. The radial shaft seal assembly of claim 1, wherein said annular retainer of said debris exclusion member is fixed to said metal case by a molded elastomeric material.

12. The radial shaft seal assembly of claim 11, wherein said annular retainer of said debris exclusion member is fixed to said metal case via a snap fit within an annular groove of said molded elastomeric material.

13. The radial shaft seal assembly of claim 1, wherein said rotatable shaft member includes a wear sleeve and a shaft, said wear sleeve having a cylindrical wall configured for a tight fit on said shaft and having an annular flange extending radially outwardly from said cylindrical wall, wherein said bristles extend radially between said annular flange and said annular leg of said metal case in clearance relation therewith.

14. The radial shaft seal assembly of claim 13, wherein said annular retainer of said debris exclusion member is fixed to said metal case.

15. The radial shaft seal assembly of claim 13, wherein said annular retainer of said debris exclusion member is fixed to said cylindrical wall.

16. The radial shaft seal assembly of claim 1, wherein said rotatable shaft member includes a wear sleeve and a shaft, said wear sleeve having a cylindrical wall configured for a tight fit on said shaft and having an annular flange extending radially outwardly from said cylindrical wall, wherein said annular flange extends radially between said bristles and said annular leg of said metal case in clearance relation therewith.

17. The radial shaft seal assembly of claim 16, wherein said annular retainer of said debris exclusion member is fixed to said metal case.

18. The radial shaft seal assembly of claim 3, wherein said at least one debris exclusion lip forms a secondary debris exclusion lip and a tertiary debris exclusion lip, said secondary debris exclusion lip extends radially inwardly from said annular leg toward said rotatable shaft member with a clearance gap being established between said secondary debris exclusion lip and said rotatable shaft member and said tertiary debris exclusion lip extends radially outwardly from said annular leg toward said debris exclusion member with a clearance gap being established between said tertiary debris exclusion lip and said debris exclusion member.

19. The radial shaft seal assembly of claim 18, wherein said debris exclusion member is fixed to said metal case with said bristles extending radially inwardly toward the rotatable shaft member.

20. The radial shaft seal assembly of claim 18, wherein said debris exclusion member is fixed to the rotatable shaft member with said bristles extending radially outwardly toward said metal case.

21. The radial shaft seal assembly of claim 1, wherein said bristles remain free from contact from said other of the rotatable shaft member or said metal case.

22. The radial shaft seal assembly of claim 1, wherein said rotatable shaft member includes a wear sleeve and a shaft, said wear sleeve having a cylindrical wall configured for a tight fit on said shaft, said retainer of the debris exclusion member being fixed to said cylindrical wall of said wear sleeve.

23. The radial shaft seal assembly of claim 22, wherein said retainer of said debris exclusion member is fixed to said wear sleeve at least in part by a folded rim of said wear sleeve cylindrical wall.

24. The radial shaft seal assembly of claim 22, wherein said wear sleeve has an annular flange extending radially outwardly from said cylindrical wall, said annular flange has cylindrical shoulder formed therein and said retainer of the debris exclusion member is fixed on said shoulder.

25. The radial shaft seal assembly of claim 24, wherein said debris exclusion member is fixed on said shoulder by a retaining washer.

26. A method of constructing radial shaft seal assembly for establishing a seal between an oil side and an air side of the assembly, comprising:
forming a metal case having a wall extending cylindrically about a central axis with an annular leg extending radially inwardly from the wall toward the central axis;
attaching a primary seal lip to the metal case and configuring the primary seal lip for running contact with a rotatable shaft member to separate the oil side of the assembly from the air side of the seal assembly; and
attaching an annular retainer, having a plurality of elongate bristles attached thereto, of a debris exclusion member to one of the rotatable shaft member or the metal case, with the bristles extending radially toward the other of the rotatable shaft member or the metal case to free ends of the bristles, and configuring the free ends of the bristles so that a clearance gap is established between the free ends and the other of the rotatable shaft member and the metal case.

27. The method of claim 26, further including bonding an elastomeric material to the leg and attaching the primary seal lip to the elastomeric material.

28. The method of claim 27, further including forming the elastomeric material to provide at least one debris exclusion lip extending toward the air side of the assembly.

29. The method of claim 28, further including forming the at least one debris exclusion lip to provide a secondary debris exclusion lip and a tertiary debris exclusion lip, and forming the secondary debris exclusion lip to extend radially inwardly from the annular leg toward the rotatable shaft member with a clearance gap being established between the secondary debris exclusion lip and the rotatable shaft member and forming the tertiary debris exclusion lip to extend radially outwardly from the annular leg toward the debris exclusion member with a clearance gap being established between the tertiary debris exclusion lip and the debris exclusion member.

30. The method of claim 28, further including fixing the debris exclusion member to the metal case with the bristles extending radially inwardly toward the rotatable shaft member.

31. The method of claim 28, further including fixing the debris exclusion member to the rotatable shaft member with the bristles extending radially outwardly toward the metal case.
